(19) United States
(12) Patent Application Publication
(10) Pub. No.: US 2012/0186003 A1
(43) Pub. Date: Jul. 26, 2012

(54) ENERGY-ABSORBING SYSTEM, METHODS OF MANUFACTURING THEREOF AND ARTICLES COMPRISING THE SAME

(75) Inventors: Ian Michael Heger, Jacksonville, FL (US); Ghatu Subhash, Gainesville, FL (US)

(73) Assignee: UNIVERSITY OF FLORIDA RESEARCH FOUNDATION, INC., Gainesville, FL (US)

(21) Appl. No.: 13/357,175

(22) Filed: Jan. 24, 2012

Related U.S. Application Data
(60) Provisional application No. 61/435,516, filed on Jan. 24, 2011.

(51) Int. Cl. A42B 3/12; F16F 9/53; F16F 9/30; F16F 7/00; B23P 11/00; A41D 13/015

(52) U.S. Cl. 2/412; 29/428; 2/413; 2/455; 188/268; 188/267.2; 188/267.1

(57) ABSTRACT

Disclosed herein is an energy-absorbing device comprising a first layer; a second layer; the second layer being opposedly disposed to the first layer and in slideablecommunication with the first layer; the first layer and the second layer enclosing a space therebetween; the space being filled with a fluid that has a power law exponent α of at least about 1.3 when measured in half cell split Hopkinson bar using Equation (3) below:

$${\vert {τ}_{w} \vert}_{ma x} = {α [ \frac{U}{h} ]}^{n} = α {\dot{γ}}^{n} \qquad ( 3 )$$

where |τ_{w}|ₘₐₓ is a maximum shear stress, γ is a shear strain rate, U is a characteristic velocity of the striker wall, h is a thickness of the space, n is a power law dimensional factor that represents an energy dissipating property of the fluid.

### CROSS-REFERENCE TO RELATED APPLICATIONS

This disclosure claims priority to U.S. Provisional Application 61/435,516 filed on Jan. 24, 2011, the entire contents of which are hereby incorporated herein by reference.

### BACKGROUND

Disclosed herein is an energy-absorbing system, methods of manufacture thereof and articles comprising the same.

Energy-absorbing devices are generally used as protective devices to minimize or reduce damage to life and limb during impacts. One example of an energy-absorbing devices is a helmet that protects the wearer against serious head injuries while participating in highly active, strenuous, or risky activities. For example, protective helmets are used during participation in sporting activities, such as football, hockey, baseball, lacrosse, cycling, mountain or rock climbing, water sports, spelunking, skateboarding, snow skiing, snow boarding, vehicular racing, roller blading, roller skating, skydiving, and the like. Protective helmets are also used for participants involved in inherently dangerous employment related activities, such as firefighting, vehicular operation, police activities, heavy construction, and the like.

Energy-absorbing devices used in sporting activities are intended to protect the wearer against suffering a head injury, such as a skull fracture or concussion after a substantial impact. A head injury occurs from either a direct impact to the head or from an indirect impacting of the head and neck while accelerating or decelerating the torso rapidly. It has been determined that the mechanism of injury for linear acceleration appears to be pressure gradient related, whereas the injury mechanism for angular acceleration is due to shear stress derived from differential motion between the head and the brain.

It has been postulated that there are two main mechanisms of head injury—direct impact, which leads to linear acceleration and impact brought on by rotational inertial loading of the head, which leads to rotational acceleration. Linear acceleration causes focal brain injuries whereas rotation acceleration causes focal and diffuse brain injuries. Studies have revealed that rotational acceleration accounts for approximately 50% of brain injuries, with the rest being due to linear acceleration. Rotational inertial forces are believed to be the underlying mechanism for most severe brain injuries.

Currently, all commercially available energy-absorbing devices are designed to protect the body and the head against large impacts brought on only by linear acceleration. It is therefore desirable to have energy-absorbing devices such as, for example, helmets that can protect the wearer against impacts and serious injuries caused by rotational acceleration.

### SUMMARY

Disclosed herein is an energy-absorbing device comprising a first layer; a second layer; the second layer being opposedly disposed to the first layer and in slideable communication with the first layer; the first layer and the second layer enclosing a space therebetween; the space being filled with a fluid that has a power law exponent n of at least about 1.3 when measured in a half cell split Hopkinson bar using Equation (3) below:

$${\vert {τ}_{w} \vert}_{ma x} = {α [ \frac{U}{h} ]}^{n} = α {\dot{γ}}^{n} \qquad ( 3 )$$

where |τ_{w}|ₘₐₓ is a maximum shear stress, γ is a shear strain rate, α is a dynamic viscosity, U is a characteristic velocity of the striking wall, h is a thickness of the space, n is the power law exponent that represents an energy dissipating property of the fluid.

Disclosed herein too is a method of manufacturing an energy-absorbing device comprising disposing a fluid in a space between a first layer and a second layer; the fluid having a power law exponent n of at least about 1.3 when measured in a half cell split Hopkinson bar using Equation (3) below:

$${\vert {τ}_{w} \vert}_{ma x} = {α [ \frac{U}{h} ]}^{n} = α {\dot{γ}}^{n} \qquad ( 3 )$$

where |τ_{w}|ₘₐₓ is a maximum shear stress, γ is a shear strain rate, α is a dynamic viscosity, U is a characteristic velocity of a striking wall, h is a thickness of the space, n is a power law exponent that represents an energy dissipating property of the fluid; and sealing the space with a seal that contacts the first layer and the second layer.

Disclosed herein is a method comprising disposing upon an article or upon a living being an energy-absorbing device comprising a first layer; a second layer; the second layer being opposedly disposed to the first layer and in slideable communication with the first layer; the first layer and the second layer enclosing a space therebetween; the space being filled with a fluid that has a power law exponent n of at least about 1.3 when measured in a half cell split Hopkinson bar using Equation (3) below:

$${\vert {τ}_{w} \vert}_{ma x} = {α [ \frac{U}{h} ]}^{n} = α {\dot{γ}}^{n} \qquad ( 3 )$$

where |τ_{w}|ₘₐₓ is a maximum shear stress, γ is a shear strain rate, α is a dynamic viscosity, U is a characteristic velocity of a striking wall, h is a thickness of the space, n is a power law exponent that represents an energy dissipating property of the fluid; and impacting the energy-absorbing device.

### BRIEF DESCRIPTION OF THE FIGURES

FIG. 1 is a depiction of an exemplary energy-absorbing device that contains a shear thickening fluid;

FIG. 2 is an exemplary depiction of an energy-absorbing helmet;

FIG. 3 is a depiction of an exemplary energy-absorbing device that contains a magnetorheological fluid or an electrorheological fluid;

FIG. 4 is a photograph of a half cell split Hopkinson bar that is used for determining properties of the shear thickening fluid;

FIG. 5 depicts the manner in which experimental measurements were made using the split Hopkinson bar and a high speed camera;

FIG. 6 is a series of photographs taken using the high speed camera for determining the displacement of a grid that is used to measure the energy absorbing capabilities of the shear thickening fluid in the split Hopkinson bar;

FIGS. 7A, 7B and 7C are plots of the dynamic viscosity versus shear strain rate for the ballistic gelatin, corn starch and the colloidal silica respectively;

FIGS. 8A, 8B and 8C are plots of energy versus time that show the dissipational energy per unit area and the kinetic energy per unit area for the ballistic gelatin, the corn starch and the colloidal silica respectively; and

FIGS. 9A and 9B depict a helmet with pouches disposed between the first layer and the second layer. Each pouch is filled with a shear thickening fluid; and

FIG. 10 is a depiction of a helmet with pouches located on the top, back, front, left side and right side of the helmet.

### DETAILED DESCRIPTION

The invention now will be described more fully hereinafter with reference to the accompanying drawings, in which various embodiments are shown. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The transition term “comprising” encompasses the transition terms “consisting of” and “consisting essentially of”.

Various numerical ranges are disclosed herein. These ranges are inclusive of the endpoints as well as numerical values between these endpoints. The numbers in these ranges are interchangeable.

Disclosed herein is an energy-absorbing device that can protect the wearer against linear acceleration as well as against rotational acceleration. The energy-absorbing layer comprises a first layer and a second layer that is opposedly disposed to the first layer, with the first layer and the second layer enclosing a space between them that is filled with a fluid. The first layer and the second layer are in slideable communication with one another.

In a first exemplary embodiment, the fluid is a shear thickening fluid that can fracture to form new surface area upon the application of shear forces to the energy-absorbing device. In a second exemplary embodiment, the fluid is a smart fluid that can turn into a shear thickening fluid upon the application of a stimulus. In one embodiment, the smart fluid can be a magnetorheological fluid whose apparent viscosity increases rapidly upon the application of a stimulus in the form of a magnetic field. In another embodiment, the smart fluid can be an electrorheological fluid whose apparent viscosity increases rapidly upon the application of stimulus in the form of an electrical field.

In one embodiment, the space between the first layer and the second layer can contain an open cell foam, which contains the fluid. The presence of the foam allows for the fluid to form surface area rapidly upon the application of shear force to either the first layer or the second layer thus absorbing a greater amount of shear energy that would be absorbed by an energy-absorbing device that contained only the fluid without the foam.

In one embodiment, the first layer is generally exposed to the exterior and contacts the source that imparts an impact to the energy-absorbing device while the second layer contacts the wearer. In another embodiment, the second layer is generally exposed to the exterior and contacts the source that imparts an impact to the energy-absorbing device while the first layer contacts the wearer. In an exemplary embodiment, the energy-absorbing device is a helmet with the first layer that is exposed to the exterior being an outer shell and the second layer that contacts the wearer being an inner shell.

The energy-absorbing device is advantageous in that upon being subjected to an impact with a rotational component, the shear force is borne by one of the layers, which slides over a film of the fluid and thus shields the second layer and the wearer from the rotational acceleration. This sliding motion of the first layer over the second layer can cause high shear stress in the fluid. The application of a high shear during the impact causes the fluid to thicken and to resist the motion until reaching a critical velocity, thus dissipating energy caused by the rotational acceleration.

In one embodiment, the shear thickening fluid undergoes shear thickening upon the application of rotational acceleration until it becomes solid-like and develops stress fractures, which create new surfaces that facilitate the dissipation of additional rotational energy. This creation of new surface area in the shear thickening fluid thus facilitates the absorption of larger amounts of energy during rotational acceleration. As a result of the sliding of the first layer over the second layer and the creation of new surface area (via fracturing) in the shear thickening fluid, the rotational energy imparted by the external impact is absorbed by the shear thickening fluid between the first and the second layers and leaves the second layer (that is in contact with the wearer) less prone to rotation and hence the wearer less prone to injuries from rotational acceleration.

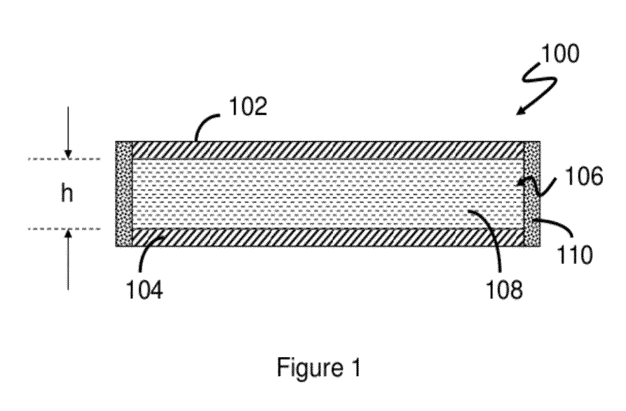

FIG. 1 is an exemplary depiction of the energy-absorbing device 100 disclosed herein. The device comprises a first layer 102 that is opposedly disposed to a second layer 104. The first layer 102 and the second layer 104 are in slideable communication with one another and enclose a space 106 that can be filled with the shear thickening fluid 108. In one embodiment, the first layer 102 is in physical communication with the second layer 104 via a seal 110 or via a pair of seals 110, 112. The seals 110 and 112 are optional. The seals 110 and 112 are flexible and permit slideable motion between the first layer 102 and the second layer 104. While the FIG. 1 shows only a first layer 102 and a second layer 104 having a fluid 108 disposed therebetween, the energy-absorbing device 100 disclosed herein can comprise a plurality of layers 102, 104, 202, 204, and the like, with each pair of opposing layers having disposed therebetween a fluid 108, 208, and so on. In one embodiment, the space 106 is generally sealed to the outside, i.e., it is an enclosed space. In other words, fluid present in the space 106 cannot be transferred from outside to the inside of the energy-absorbing device or vice versa unless it is accomplished through a valve or a flow device.

The first layer 102 and the second layer 104 are leak proof layers (that prevents the fluid from escaping through them) that can be rigid or flexible. In one embodiment, the first layer 102 is rigid (i.e., having an elastic modulus of greater than 10⁶ pascals at room temperature when measured in a tensile test as per ASTM D 638). A flexible layer as defined herein has an elastic modulus of less than 10⁶ pascals at room temperature when measured in a tensile test as per ASTM D 638. The rigid first layer 102 prevents penetration of the wearer by a pointed object. The rigid first layer 102 also provides protection to the second layer 104 so that it does not disintegrate upon abrasive contact with a hard or rough surface (e.g., a pavement). While the FIG. 1 shows the first layer 102 and the second layer 104 as being flat surfaces, the respective layers can be curved as desired with the layers rotating within one another.

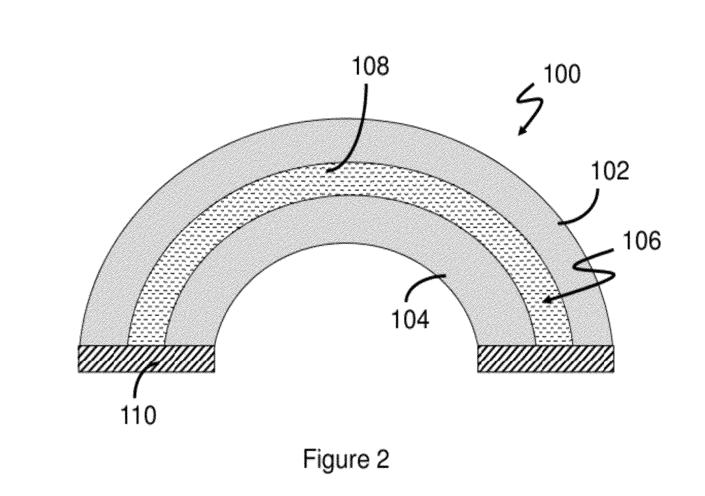

The FIG. 2 shows an embodiment, where the energy-absorbing device 100 is a helmet. The helmet comprises a first layer 102 and a second layer 104 that are in slideable communication with one another and creating an enclosure 106 therebetween. The enclosure 106 contains a fluid 108. The ends of the first layer 102 and the second layer 104 are contacted by a seal that serves to prevent leakage of the fluid from the helmet.

In one embodiment, when the energy-absorbing device 100 is a helmet, the first layer 102 is rigid and comprises a fiber reinforced organic polymer or an organic polymer that has a high impact strength. Examples of fibers that are used in fiber reinforced organic polymers are KEVLAR®, glass fibers, carbon fibers, and the like. Examples of polymers that can be used in the fiber reinforced organic polymers are polystyrenes, polyolefins, polyesters, polyamides, polyamideimides, polyarylates, polyarylsulfones, polyethersulfones, polyphenylene sulfides, polysulfones, polyimides, polyetherimides, polyetherketones, polyether etherketones, polyether ketone ketones, polybenzoxazoles, polyphthalides, or the like, or a combination comprising at least one of the foregoing organic polymers.

Examples of organic polymers that have high impact strength are polycarbonates, polycarbonate-polyester copolymers, impact modified polymers such as high impact polystyrene, acrylonitrile butadiene styrene, or the like, or a combination comprising at least one of the foregoing organic polymers.

The second layer 104 can also be a flexible or a rigid layer. In one embodiment, when the energy-absorbing device is a helmet, the second layer 104 can comprise a foam that comprises a polyurethane, a polystyrene, a polyolefin (e.g., a polyethylene, a propylene, or a combination thereof), a polyvinylchloride, or the like. In a helmet, the second layer 104 is considerably thicker than the first layer 102 and is to be capable of damping or absorbing impacts against the head.

In one embodiment, the fluid 108 that is disposed on the space 106 is a shear thickening fluid. The space 106 has a thickness “h” of about 0.01 millimeter to about 8 millimeters, specifically about 0.1 millimeter to about 5 millimeters, and more specifically about 1 millimeter to about 3 millimeters. In an exemplary embodiment, it is desirable for the thickness of the fluid layer disposed between the first layer 102 and the second layer 104 to be greater than or equal to about 2 millimeters thick, specifically greater than or equal to about 2.5 millimeters thick and more specifically greater than or equal to about 3.0 millimeters thick.

A shear thickening fluid is one in which viscosity increases with the rate of shear. The “shear thickening” effect occurs when closely packed particles are combined with enough liquid to fill the gaps between them. At low velocities, the liquid acts as a lubricant, and the fluid flows easily. At higher velocities, the liquid is unable to fill the gaps created between particles, and friction greatly increases, causing an increase in viscosity.

The shear thickening fluid can be any fluid whose viscosity increases with the rate of shear. In one embodiment, it is desirable for the shear thickening fluid to have a carrier fluid with filler particles dispersed therein. In one embodiment, the carrier fluid is a low molecular weight fluid (i.e., having a molecular weight below 200 grams per mole). In another embodiment, the carrier fluid is a high molecular weight fluid (i.e., having a molecular weight greater than 200 grams per mole). In yet another embodiment, the carrier fluid comprises both low molecular weight fluids and high molecular weight fluids.

Examples of low molecular weight carrier fluids are water, ethanol, silicone oils, fluorocarbon oils, hydrocarbon oils (e.g., paraffin oils), mineral oils, hydraulic oils, transformer oils, or the like, or a combination comprising at least one of the foregoing low molecular weight fluids. In an exemplary embodiment, the shear thickening fluid is an aqueous fluid.

Examples of high molecular weight carrier fluids are organic polymers. The organic polymer can be a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers. Examples of suitable polymers are polyacrylamides; polyacrylic acids; polymethacrylic acids; cellulose (e.g., hydroxypropyl methyl cellulose, hydroxypropyl cellulose, methyl cellulose, ore the like); copolymers of acrylamide and acrylic or methacrylic acid; blends of polyacrylamide and polycarboxylic acid; polyalkylene oxides (e.g., polyethylene glycol, polymethylene glycol, polytetramethylene glycol, or the like); polysaccharides (starches, pectin, or the like); proteins (e.g., collagen, egg whites, furcellaran, gelatin, ballistic gelatin, or the like); arrowroot, cornstarch, katakuri starch, potato starch, sago, tapioca; vegetable gums (e.g., alginin, guar gum, locust bean gum, xanthan gum, or the like); sugars (e.g., agar, carrageenan, or the like); or a combination comprising at least one of the foregoing high molecular weight carrier fluids.

In an exemplary embodiment, the shear thickening fluid comprises gelatin powder and water. The gelatin is generally present in an amount of about 3 wt % to about 30 wt %, specifically about 5 wt % to about 20 wt %, and more specifically about 7 to about 15 wt %, based on the total weight of the shear thickening fluid.

The shear thickening fluid comprising gelatin powder and water is first prepared by mixing water with gelatin powder (to form a mixture) at a temperature of 7 to about 30° C. Hot water at a temperature of about 50° C. to about 80° C. is then added to the mixture and stirred until all of the gelatin is completely dissolved. Defoamer may be added to prevent the formation of foams and bubbles in the shear thickening fluid.

In another exemplary embodiment, the shear thickening fluid comprises corn starch and water. The corn starch may be present in the shear thickening fluid in an amount of about 10 to about 40 wt %, specifically about 15 to about 35 wt % and more specifically about 20 to about 30 wt %, based on the total weight of the shear thickening fluid.

In yet another exemplary embodiment, the shear thickening fluid is colloidal silica or colloidal alumina or a mixture thereof.

The dynamic viscosity of the carrier fluid is about 3 to about 400 pascal-seconds, specifically about 5 to about 300 pascal-seconds, and more specifically about 7 to about 200 pascal-seconds when measured at a shear strain rate of about 1000 to about 12000 seconds⁻¹ (s⁻¹), specifically about 1500 to about 10000 s⁻¹, and more specifically about 2000 to about 9000 s⁻¹.

The filler particles may be synthetic and/or naturally occurring minerals. Examples of filler particles that can be used in the shear thickening fluid are clays such as for example, bentonite, hectorite, smectite, attapulgite clays, or the like, or a combination comprising at least one of the foregoing clays; colloidal metal oxides such as colloidal silica, colloidal alumina, colloidal titania, colloidal zirconia, colloidal ceria, or the like, or a combination comprising at least one of the foregoing metal oxides; metals such as colloidal gold, silver, or the like, or a combination comprising at least one of the foregoing metals; calcium carbonate; polymers such as polystyrene, polyacrylate, polymethylmethacrylate, or other polymers derived from emulsion polymerization, or the like, or a combination comprising at least one of the foregoing polymers. Mixtures of the foregoing fillers can also be used.

The filler particles can be stabilized in the carrier fluid by electrical charges, Brownian motion, adsorbed surfactants, adsorbed or grafted polymers, polyelectrolytes, polyampholytes or oligomers. In one embodiment, the filler particles are nanoparticles. Particle shapes include spherical particles, elliptical, biaxial, rhombohedral, cubic, and rod-like particles, or disk-like or clay particles. The particles can be monodisperse, bidisperse or polydisperse in size and shape. It is desirable for the filler particles to have sizes of about 20 Angstroms to about 1 millimeter; specifically about 200 Angstroms to about 100 micrometers, and more specifically about 400 Angstroms to about 20 micrometers.

The filler particles are present in the shear thickening fluid in amounts of 0.5 to about 20 wt %, specifically about 1 to about 10 wt %, and more specifically about 1.5 to about 5 wt %, based on the total weight of the shear thickening fluid. In an exemplary embodiment, the shear thickening fluid is a water based fluid where water is the carrier fluid. The shear thickening fluid may contain other additives such as stabilizers, antibacterial agents, buffering agents, surfactants, salts, and the like.

As noted above, smart fluids such as magnetorheological fluids or electrorheological fluids may also be used in the space 106 between the first layer 102 and the second layer 104. The term magnetorheological fluid encompasses magnetorheological fluids, ferrofluids, colloidal magnetic fluids, and the like. Magnetorheological (MR) fluids and elastomers are known as “smart” materials whose rheological properties can rapidly change upon application of a magnetic field. Similarly, electrorheological fluids (ER) are “smart” materials whose rheological properties can rapidly change upon application of an electrical field.

MR fluids are suspensions of micrometer-sized, magnetically polarizable particles in oil or other liquids. When a MR fluid is exposed to a magnetic field, the normally randomly oriented particles form chains of particles in the direction of the magnetic field lines. The particle chains increase the apparent viscosity (flow resistance) of the fluid. The stiffness of the structure is accomplished by changing the shear and compression/tension modulii of the MR fluid by varying the strength of the applied magnetic field. The MR fluids typically develop structure when exposed to a magnetic field in as little as a few milliseconds. Discontinuing the exposure of the MR fluid to the magnetic field reverses the process and the fluid returns to a lower viscosity state.

Suitable magnetorheological fluids include ferromagnetic or paramagnetic particles dispersed in a carrier fluid. Suitable particles include iron; iron alloys, such as those including aluminum, silicon, cobalt, nickel, vanadium, molybdenum, chromium, tungsten, manganese and/or copper; iron oxides, including Fe₂O₃ and Fe₃O₄; iron nitride; iron carbide; carbonyl iron; nickel and alloys of nickel; cobalt and alloys of cobalt; chromium dioxide; stainless steel; silicon steel; or the like, or a combination comprising at least one of the foregoing particles. Examples of suitable iron particles include straight iron powders, reduced iron powders, iron oxide powder/straight iron powder mixtures and iron oxide powder/reduced iron powder mixtures. A preferred magnetic-responsive particulate is carbonyl iron, preferably, reduced carbonyl iron.

The particle size should be selected so that the particles exhibit multi-domain characteristics when subjected to a magnetic field. Diameter sizes for the particles can be less than or equal to about 1,000 micrometers, specifically less than or equal to about 500 micrometers, and specifically less than or equal to about 100 micrometers. It is desirable to have particles with a particle diameter of greater than or equal to about 0.1 micrometer, specifically greater than or equal to about 0.5, and more specifically greater than or equal to about 10 micrometer especially preferred. The particles are preferably present in an amount between about 5.0 and about 60 percent by volume of the total MR fluid composition.

Suitable carrier fluids for the MR fluid composition include organic liquids, especially non-polar organic liquids. Examples include, but are not limited to, silicone oils; mineral oils; paraffin oils; silicone copolymers; white oils; hydraulic oils; transformer oils; halogenated organic liquids, such as chlorinated hydrocarbons, halogenated paraffins, perfluorinated polyethers and fluorinated hydrocarbons; diesters; polyoxyalkylenes; fluorinated silicones; cyanoalkyl siloxanes; glycols; synthetic hydrocarbon oils, including both unsaturated and saturated; and combinations comprising at least one of the foregoing fluids.

The viscosity of the carrier fluid for the MR fluid composition can be less than or equal to about 100,000 centipoise, specifically less than or equal to about 10,000 centipoise, and more specifically less than or equal to about 1,000 centipoise at room temperature. It is also desirable for the viscosity of the carrier fluid to be greater than or equal to about 1 centipoise, specifically greater than or equal to about 250 centipoise, and more specifically greater than or equal to about 500 centipoise at room temperature.

Aqueous carrier fluids may also be used, especially those comprising hydrophilic mineral clays such as bentonite and hectorite. The aqueous carrier fluid may comprise water or water comprising a small amount of polar, water-miscible organic solvents such as methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like. The amount of polar organic solvents is less than or equal to about 5.0% by volume of the total MR fluid, and specifically less than or equal to about 3.0%. Also, the amount of polar organic solvents is specifically greater than or equal to about 0.1%, and more specifically greater than or equal to about 1.0% by volume of the total MR fluid. The pH of the aqueous carrier fluid is specifically less than or equal to about 13, and specifically less or equal to about 9.0. Also, the pH of the aqueous carrier fluid is greater than or equal to about 5.0, and specifically greater than or equal to about 8.0.

Natural or synthetic bentonite or hectorite may be used. The amount of bentonite or hectorite in the MR fluid is less than or equal to about 10 percent by weight of the total MR fluid, specifically less than or equal to about 8.0 percent by weight, and more specifically less than or equal to about 6.0 percent by weight. Preferably, the bentonite or hectorite is present in greater than or equal to about 0.1 percent by weight, specifically greater than or equal to about 1.0 percent by weight, and more specifically greater than or equal to about 2.0 percent by weight of the total MR fluid.

Optional components in the MR fluid include clays, organoclays, carboxylate soaps, dispersants, corrosion inhibitors, lubricants, extreme pressure anti-wear additives, antioxidants, thixotropic agents and conventional suspension agents. Carboxylate soaps include ferrous oleate, ferrous naphthenate, ferrous stearate, aluminum di- and tri-stearate, lithium stearate, calcium stearate, zinc stearate and sodium stearate, and surfactants such as sulfonates, phosphate esters, stearic acid, glycerol monooleate, sorbitan sesquioleate, laurates, fatty acids, fatty alcohols, fluoroaliphatic polymeric esters, and titanate, aluminate and zirconate coupling agents and the like. Polyalkylene diols, such as polyethylene glycol, and partially esterified polyols can also be included.

Electrorheological fluids are most commonly colloidal suspensions of fine particles in non-conducting fluids. Under an applied electric field, electrorheological fluids form fibrous structures that are parallel to the applied field and can increase in viscosity by a factor of up to 10⁵. The change in viscosity is generally proportional to the applied potential. ER fluids are made by suspending particles in a liquid whose dielectric constant or conductivity is mismatched in order to create dipole particle interactions in the presence of an alternating current (ac) or direct current (dc) electric field.

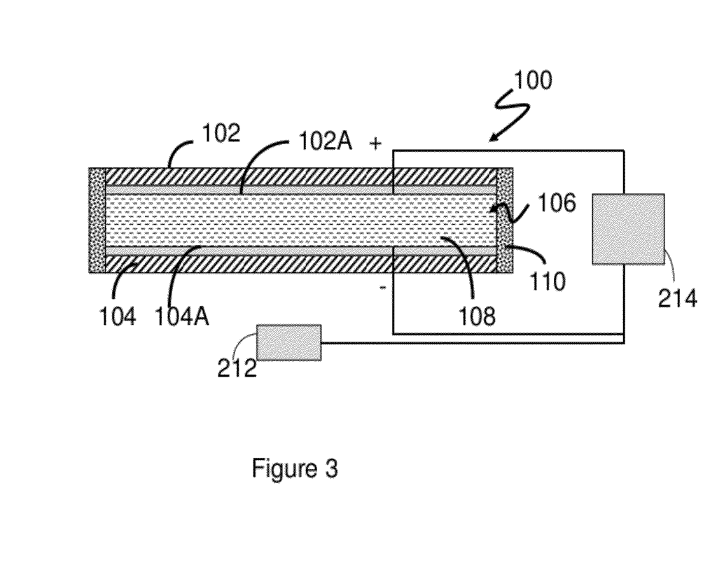

The FIG. 3 depicts one exemplary embodiment of an exemplary energy-absorbing device 100 that uses magnetorheological or electrorheological fluids. The device comprises a first layer 102 that is opposedly disposed to a second layer 104. The first layer 102 and the second layer 104 are in slideable communication with one another and enclose a space 106 that can be filled with the magnetorheological fluid 108 or an electrorheological fluid.

The first layer 102 and the second layer 104 have opposing surfaces 102A and 104A that can function as electromagnets. A strain gauge 212 can be disposed between the second layer 104 and the wearer of the energy-absorbing device 100. The strain gauge 212 communicates with an activation device 214. Upon receiving a signal from the strain gauge of an impact, the activation device 214 delivers an activation signal to a source of power. The source of power activates the electromagnets 102A and 104A thereby causing the viscosity of the magnetorheological fluid to be increased. The increase in the viscosity of the magnetorheological fluid causes the rotational energy to be absorbed as detailed above.

In a similar manner, the opposing surfaces 102A and 104A can be electrodes and the fluid contained in the space 106 can be an electrorheological fluid. Upon receiving an electrical signal from the strain gauge 212, the activation device 214 delivers a signal to a source of power which causes the electrorheological fluid to increase in viscosity, thus absorbing energy from the impact.

With reference now once again to the FIGS. 1 and 2, a foam (not shown) may optionally be disposed in the space 106 between the first layer 102 and the second layer 104. The foam is an open cell foam and is immersed with the shear thickening fluid 106. The foam can be manufactured from an organic polymer. Any of the aforementioned polymers can be used to produce the foam. In one embodiment, it is desirable to use a foam that does not have a chemical affinity for the carrier fluid. Because of the lack of affinity between the foam and the carrier fluid, when the energy-absorbing device 100 encounters an impact, the shear thickening fluid increases in viscosity. However, because of the lack of compatibility between the shear thickening fluid and the material of the foam, the shear thickening fluid rapidly separates from the foam thus creating new surface area and absorbing a larger amount of rotational acceleration.

In one embodiment, the difference in compatibility between the carrier fluid and the organic polymer used in the foam can be expressed in terms of a solubility parameter. The solubility parameter is a numerical parameter, which indicates the relative solvency behavior of a specific solvent or the compatibility between a solvent and a polymer. It is derived from the cohesive energy density of a solvent. From the heat of vaporization in calories per cubic centimeter of liquid, the cohesive energy density (c) can be derived by the following expression shown in Equation (1) below:

$$c = \frac{Δ H - RT}{{V}_{m}} \qquad ( 1 )$$

where

c=cohesive energy density

ΔH=heat of vaporization

R=gas constant

T=temperature; and

Vₘ=molar volume.

Since the solubility parameter of two materials is only possible when their intermolecular attractive forces are similar, one might also expect that materials with similar cohesive energy density values would be miscible. The solubility parameter is the square root of the cohesive energy density. In choosing a solvent to be compatible with a polymer, it is therefore desirable to choose a solvent with a solubility parameters that is similar to that of the polymer. In metric units, the solubility parameter (δ) can be calculated in calories per cubic centimeter in metric units (cal^{1/2}cm^{-3/2}). In SI units, the solubility parameter is expressed in megapascals (MPa^{1/2}). The conversion of the solubility parameter from SI units to metric units is given by the Equation (2).

δ(MPa^{1/2})=2.0455×δ(cal^{1/2}cm^{-3/2}) (2)

The solubility parameter can be used to predict the solvency of a particular solvent for another solvent or for a film of solid (e.g., polymers, salts, waxes, and the like). It is desirable to use a carrier fluid and a foam that have a difference of greater than or equal to about 5 MPa^{1/2}, specifically greater than or equal to about 7 MPa^{1/2}, more specifically greater than or equal to about 10 MPa^{1/2} and even more specifically greater than or equal to about 10 MPa^{1/2}.

For example, it is desirable to have the foam comprising a polyolefin, a polysiloxane or a polyfluorocarbon (polytetrafluoroethylene), while the carrier fluid comprises water, alcohol or a water alcohol mixture.

The seals 110, 112 can perform a variety of functions such as for example, prevent leakage of the shear thickening fluid from the space 106 energy-absorbing device 100. In one embodiment, the seals 110 and 112 can house a valve (not shown) for filling the space 106 with the shear thickening fluid 108. In one embodiment, the valve is a one-way valve that permits the shear-thickening fluid to be pumped into the space 106 without allowing it to be removed from the energy-absorbing device 100. The seals 110 and/or 112 are generally manufactured from a flexible material such as for example an elastomer. The seal thus functions to prevent leakage of the fluid while at the same time permitting the first layer 102 and the second layer 104 to remain in slideable communication with one another.

The energy-absorbing device 100 can absorb rotational energy per unit area of about 450 joules per square meter (J/m²) to about 15,000 J/m², without causing any brain injuries to a wearer. In an exemplary embodiment, the energy-absorbing device 100 can absorb rotational energy of about 1,000 J/m² to about 10,000 J/m², without causing any brain injuries to a wearer.

The energy-absorbing device can include a shear thickening fluid having a power law exponent (n) as determined from the Equation (3) (discussed in detail below) that is greater than or equal to about 1.3, specifically greater than or equal to about 1.5, specifically greater than or equal to about 1.8, specifically greater than or equal to about 2.2, specifically greater than or equal to about 2.5, specifically greater than or equal to about 3.0, specifically greater than or equal to about 3.5, and more specifically greater than or equal to about 4.5. The shear thickening fluid can have a value of n of up to about 10.

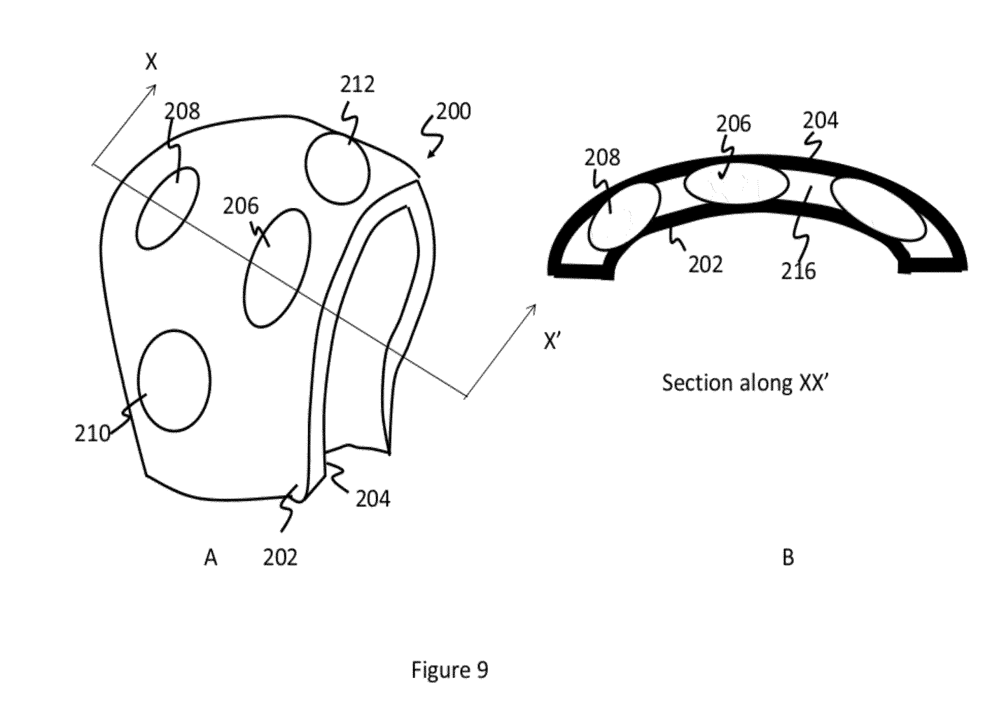

In one embodiment, the energy absorbing device comprises one or more pouches of a first fluid disposed between the first layer and the second layer. With reference to the FIG. 9A, is depicted a helmet 200 that comprises a first layer 202 and a second layer 204 having a plurality of pouches 206, 208, 210, 212 disposed therebetween. The FIG. 9B represents a cross-section of the FIG. 9A taken at section XX′. In the FIG. 9B, it may be seen that each of the plurality of pouches contains a first fluid. The first fluid is the shear thickening fluid described above. Disposed in the regions 216 between the first layer 202 and the second layer 204 and the plurality of pouches 206, 208, 210 and 212 is a second fluid. In one embodiment, the second fluid may also be a shear thickening fluid. In another embodiment, the second fluid may be a non-shear thickening fluid, In an exemplary embodiment, the second fluid is air.

The pouches may be periodically spaced or a periodically spaced. In an exemplary embodiment, the energy absorbing device is a helmet with at least one pouch disposed at the top of the helmet, at least one pouch disposed on the left side of the helmet, one pouch disposed on the right side of the helmet, at least one pouch disposed on the back side of the helmet, and at least one pouch disposed on the front of the helmet.

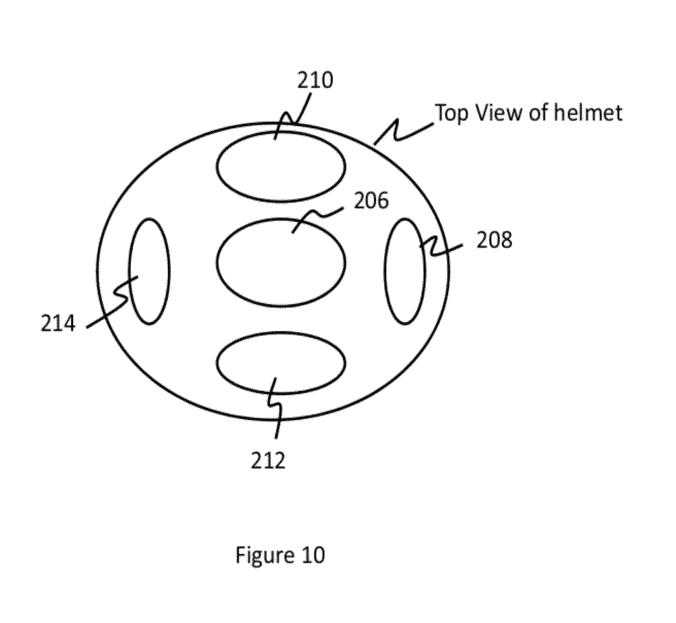

FIG. 10 depicts one such helmet with the pouch 206 disposed on the top of the helmet, pouch 208 disposed on the front of the helmet, pouch 210 disposed on the left side of the helmet, pouch 212 disposed on the right side of the helmet and pouch 214 disposed on the back of the helmet.

In one embodiment, in one method of manufacturing the energy-absorbing device 100, the first layer 102 and the second layer 104 are placed proximate to one another. A seal 110 contacts the first layer 102 and the second layer 104 in a manner so as to prevent leakage from the energy-absorbing device. A fluid 108 may then be introduced into the space 106 between the first and the second layers. The fluid 108 may be introduced into the space 106 via a valve in the seal.

In another embodiment, in one method of manufacturing the energy-absorbing device 100, the first layer 102 and the second layer 104 are placed proximate to one another. The space 106 between the first layer 102 and the second layer 104 is first filled with a fluid 108. Following the filling of the space with the fluid, a seal that contacts both the first layer 102 and the second layer 104 is put into position thus securing the fluid 108 in the space 106.

The energy-absorbing device thus formed can be used in a variety of different applications such as for example helmets that are used by the military or for recreational sports. These energy-absorbing devices can also be used for improved body pads for recreational sports, for commercial applications and for military applications where protection from high velocity impact is desired. The energy-absorbing devices can also be used in the protective padding of commercial transportation vehicles and locomotives and other areas where injuries to the head are likely to occur during accidents. An exemplary location for the energy-absorbing device can be the dashboard and the steering wheel of an automobile.

The following examples, which are meant to be exemplary, not limiting, illustrate compositions and methods of testing of some of the various embodiments described herein.

### EXAMPLE

### Example 1

The following examples were conducted to demonstrate that shear thickening fluids can be used in energy-absorbing devices as disclosed above. The examples were also conducted to demonstrate the shear thickening properties of commercially available fluids that can be used in the energy-absorbing devices.

In order to test various fluids for shear thickening properties in the energy-absorbing device, a constitutive equation was developed to determine material parameters that indicate the utility of various fluids for a given application. The constitutive equation (represented by Equation (3)) is as follows:

$${\vert {τ}_{w} \vert}_{ma x} = {α [ \frac{U}{h} ]}^{n} = α {\dot{γ}}^{n} \qquad ( 3 )$$

where |τ_{w}|ₘₐₓ is a maximum shear stress, γ is a shear strain rate, α is a dynamic viscosity, U is a characteristic velocity of a striking wall, h is a thickness of the fluid specimen (the distance between the parallel plates, e.g., the distance between the first layer 102 and the second layer 104), n is a power law exponent that is indicative of the energy dissipating properties of the shear thickening fluid.

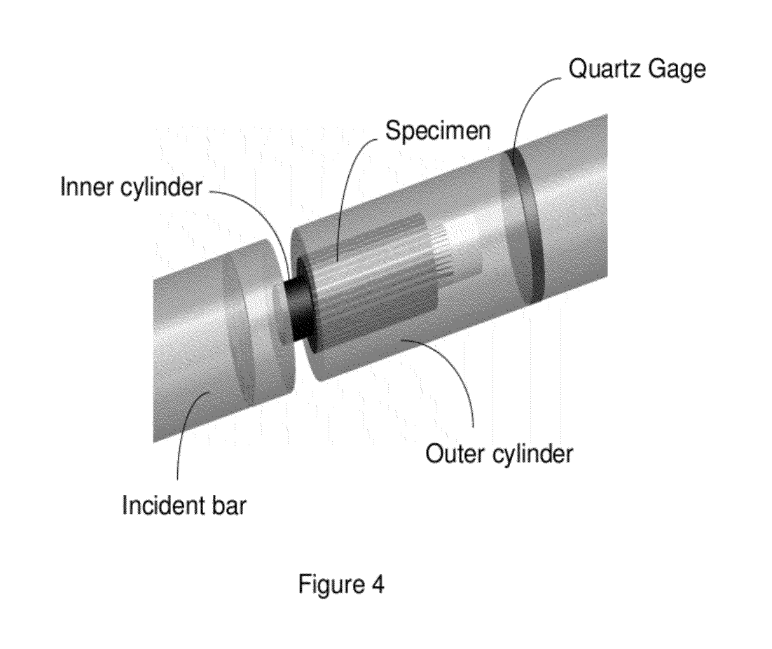

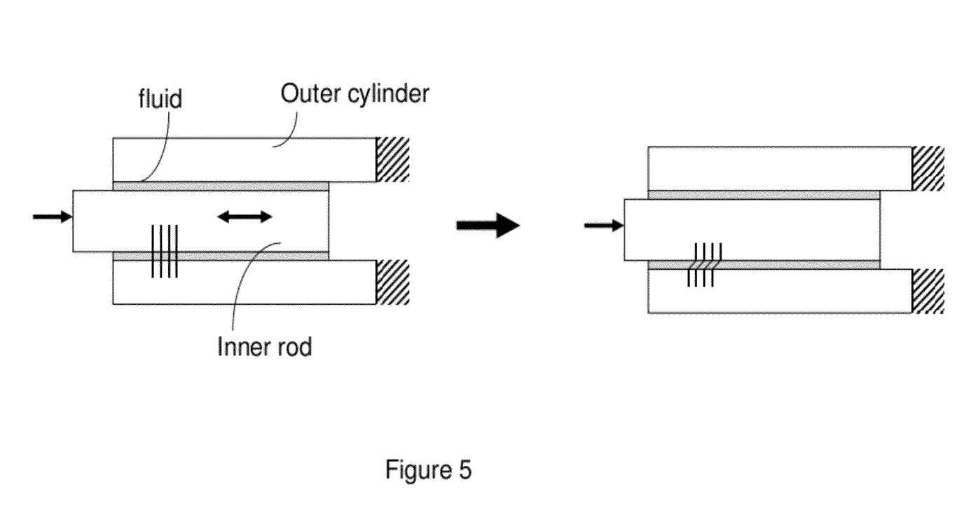

In order to test the various fluids, a half-cell split Hopkinson pressure bar was used. The split Hopkinson bar (cell) is shown in the FIG. 4 and comprises an outer sleeve, an inner rod and an end-cap. The cell is designed to hold a fluid between the inner rod and the outer sleeve. The inner rod is cylindrical, while the outer sleeve is tubular. A half-cell split Hopkinson pressure bar (SHPB) was used in order to monitor shear deformation in-situ by using a high speed camera. The high-speed camera was used to capture the displacement in grid lines that extend onto the inner rod and outer cylinder boundaries as shown in the FIG. 5.

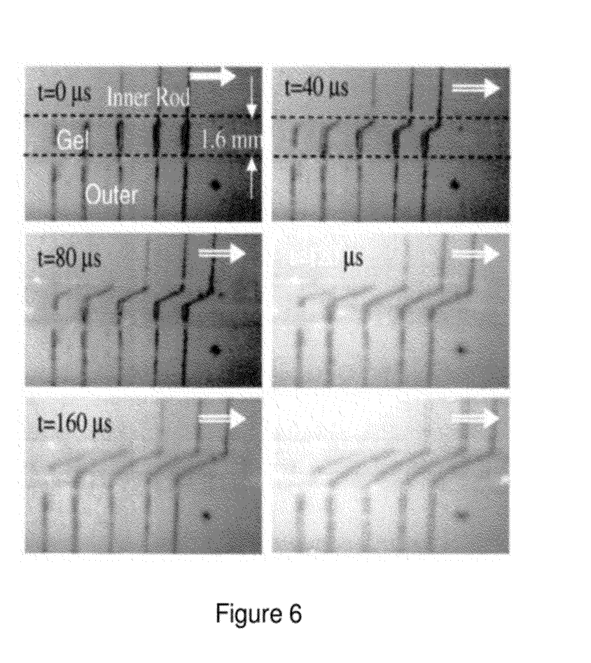

From the FIG. 5, it may be seen that as the inner rod is displaced by a given force (a striking wall), the grid lines in the fluid are displaced and this displacement is captured on the high speed camera. This method provides information on the time taken for the development of momentum in the fluid, when the fluid is subjected to a displacement as a result of forces applied to the inner rod of the split Hopkinson bar. The shear stress transmitted through the fluid is measured using a thin piezoelectric sensor placed at the opposing end of the fluid specimen from the end where the force is applied. Knowing the transmitted stress and the deformation pattern in the fluid, one can extract the non-Newtonian properties of the fluid. The time history of displacement of the fluid markers in the early stage of the fluid diffusion when the local shear rate is extremely high is used to extract the parameters in the power law equation for each fluid. Knowing the shear stress (measured the piezoelectric quartz gauge), and the input velocity (measured using the high speed images) and thickness of the fluid specimen, the values of α and n in the Equation (3) can be determined for different fluids. The FIG. 6 shows images from the high speed camera revealing transient shear deformation behavior for the gel when subjected to a given displacement in the split Hopkinson bar.

The energy dissipated by the shear thickening fluids was also calculated. The total input energy from the displacement of the inner rod relative to the walls of the split Hopkinson bar can be separated into two parts a) dissipated through deformation in the gels and b) energy through fluid motion. The total energy per unit area is expressed in the Equation (4) as follows:

e_{T}(t)=e_{d}(t)+eₖ(t)+β (4)

where e_{T}(t) is the total energy per unit area, e_{d}(t) is the dissipational energy per unit area as detailed by (a) above, and eₖ(t) is the kinetic energy per unit area and β is the elastic potential energy. It is to be noted that the term β encompasses experimental uncertainty. It is also to be noted that the elastic potential energy represented by β may not exist under certain conditions.

Three different shear thickening fluids were chosen for measurement. These fluids are ballistic gelatin, corn starch and colloidal silica.

The ballistic gelatin was prepared as follows. One part of the gelatin powder (purchased from Vyse-Gelatin innovations, Schiller park, Ill.) was mixed with two parts of the filtered water (at a temperature of 7 to 27° C.) in a 1:2 ratio by weight. Hot water (at 60° C.) was added to the mixture in a 7:3 ratio by weight and stirred for 15 seconds at regular intervals until the powder was completely dissolved. To avoid bubble formation, a drop of de-foamer was added to the mixture during the stirring process. The resulting gelatin is called ‘ballistic gelatin’ (with a bloom of 250). This solution was poured in to the acrylic mold to form the specimen.

The corn starch and colloidal silica were obtained from commercial manufacturers. The cornstarch solution was prepared from corn starch powder from Fisher Science Education (4500 Tumberry Drive, Hanover Park, Ill. 60133). It was cooked in boiling water to prepare the solution at 30 wt % corn starch.

The colloidal silica was obtained from Allied High Tech Products Inc, 2376 East Pacifica Place, Rancho Dominguez, Calif. 90220 (product #180-70015). It contained 0.05 micron colloidal Silica/Alumina suspension.

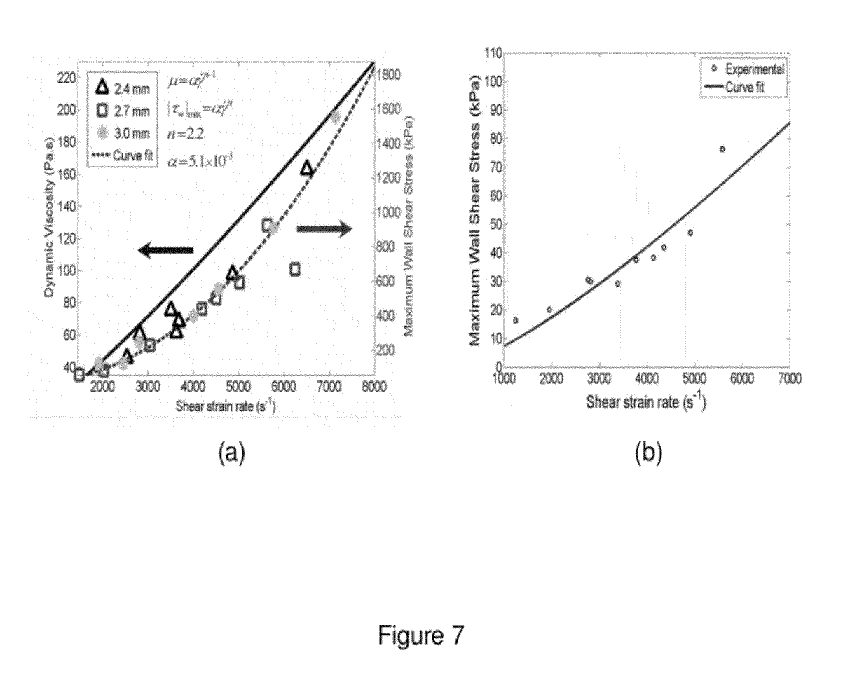

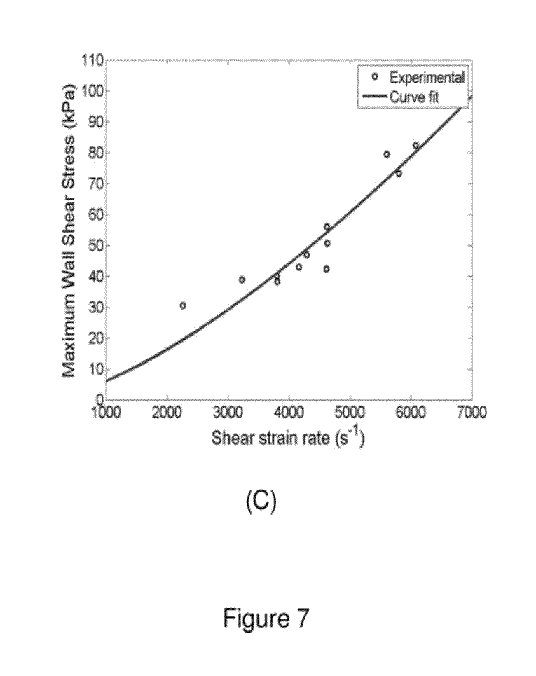

The FIGS. 7A, 7B and 7C are plots of the dynamic viscosity versus shear strain rate for the ballistic gelatin, corn starch and the colloidal silica respectively. The plots also reflect the maximum wall shear stress versus the strain rate for the ballistic gelatin, corn starch and the colloidal silica respectively.

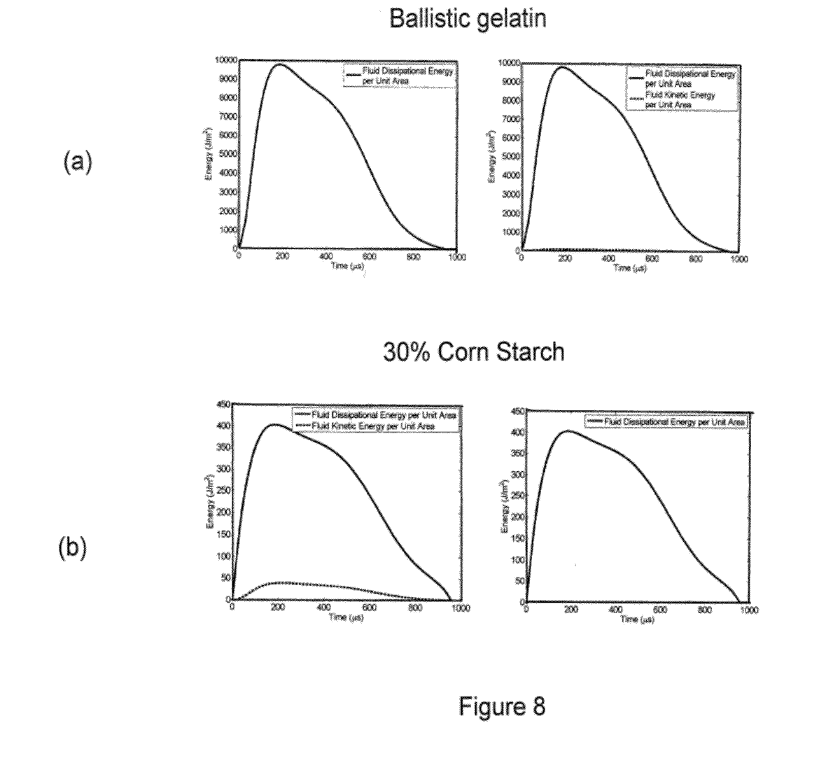

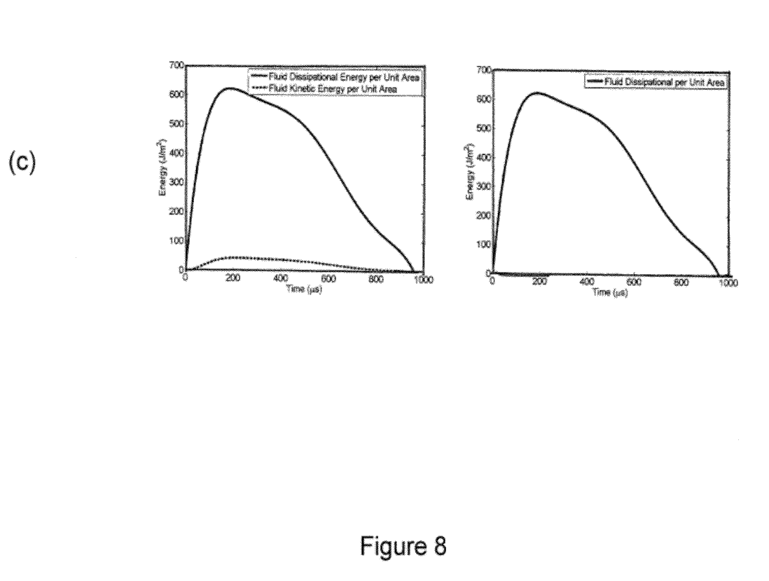

The FIGS. 8A, 8B and 8C are plots of energy versus time that show the dissipational energy per unit area and the kinetic energy per unit area for the ballistic gelatin, the corn starch and the colloidal silica respectively.

The a values calculated from the Equation (3) and the dissipational energy and kinetic energy values obtained from Equation (4) are shown in the Table 1 below.

TABLE 1

| | | | Total maximum | Total maximum |
|---|---|---|---|---|
| | | | energy per unit | energy for |
| | Specified | | area for | specified |
| | Thickness | | specified | specimen |
| Material | (mm) | n | thickness (J/m²) | dimension (J) |
| Ballistic gelatin | 2.4 | 2.2 | 10,000 | 12 |
| 30 wt % corn | 2.0 | 1.4 | 450 | 1 |
| starch | | | | |
| Colloidal silica | 2.0 | 1.3 | 650 | 1.5 |

From the Table 1 above, it may be sent that ballistic gelatin has the best energy absorbing capability. The ballistic gelatin has a n value that is greater than those of the 30 wt % corn starch and the colloidal silica. From the FIG. 8A it may be seen that the energy absorbed by the ballistic gelatin over a period of 200 microseconds is over at least 3 orders of magnitude, thus making it a suitable fluid for absorbing shear stress. While the Table 1 and the graphs from the FIGS. 7A, 7B, 7C, 8A, 8B and 8C each show that the ballistic gelatin performed best among the three selected compositions, it is believed that the other compositions—the corn starch and the colloidal silica could each be used in other energy-absorbing applications. The corn starch and the colloidal silica could each be modified (for example, by incorporating a larger amount of silica particles and corn starch in the respective compositions) to absorb a larger amount of energy in a short time.

From the aforementioned examples, it may be seen that an energy-absorbing device having a fluid channel of thickness of at least about 2 millimeters and filled with a shear thickening fluid having a power law exponent n of at least about 1.3 would be suitable for protecting the body parts of a wearer. In one embodiment, it is desirable to have an energy-absorbing device having a fluid channel of thickness of at least about 2.5 millimeters, specifically at least about 2.8 millimeters, and more specifically at least about 3.0 millimeters and filled with a shear thickening fluid having a power law exponent of at least about 1.3, specifically at least about 1.8, and more specifically at least about 2.2, would be suitable for protecting the body parts of a wearer.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the invention not be limited to the particular embodiment disclosed as the best mode contemplated for carrying out this disclosure.

What is claimed is:

1. An energy-absorbing device comprising:
a first layer;
a second layer; the second layer being opposedly disposed to the first layer and in slideable communication with the first layer; the first layer and the second layer enclosing a space therebetween; the space being filled with a fluid that has a power law exponent n of at least about 1.3 when measured in half cell split Hopkinson bar using Equation (3) below:
$${\vert {τ}_{w} \vert}_{ma x} = {α [ \frac{U}{h} ]}^{n} = α {\dot{γ}}^{n} \qquad ( 3 )$$
where |τ_{w}|ₘₐₓ is a maximum shear stress, γ is a shear strain rate, α is a dynamic viscosity, U is a characteristic velocity of the striking wall, h is a thickness of the space, n is a power law exponent that represents an energy dissipating property of the fluid.

2. The energy-absorbing device of claim 1, where the space is an enclosed space.

3. The energy-absorbing device of claim 1, where the fluid is a shear thickening fluid.

4. The energy-absorbing device of claim 1, where the fluid is a magnetorheological fluid.

5. The energy-absorbing device of claim 1, where the fluid is an electrorheological fluid.

6. The energy-absorbing device of claim 1, where h is greater than or equal to about 2 millimeters.

7. The energy-absorbing device of claim 1, where the fluid has a viscosity of about 1 to about 100,000 centipoise.

8. The energy-absorbing device of claim 1, where the fluid comprises water, ethanol, silicone oils, fluorocarbon oils, paraffin oils, mineral oils, hydraulic oils, transformer oils, or a combination comprising at least one of the foregoing low molecular weight fluids.

9. The energy-absorbing device of claim 1, where the fluid comprises an organic polymer.

10. The energy-absorbing device of claim 9, where the organic polymer comprises a homopolymer, a copolymer, a block copolymer, an alternating copolymer, an alternating block copolymer, a random copolymer, a random block copolymer, a graft copolymer, a star block copolymer, an ionomer, a dendrimer, or a combination comprising at least one of the foregoing polymers.

11. The energy-absorbing device of claim 1, where the fluid comprises polyacrylamides; polyacrylic acids; polymethacrylic acids; cellulose; hydroxypropyl methyl cellulose; hydroxypropyl cellulose; methyl cellulose; copolymers of acrylamide and acrylic or methacrylic acid; blends of polyacrylamide and polycarboxylic acid; polyalkylene oxides; polyethylene glycol; polymethylene glycol; polytetramethylene glycol; polysaccharides; starches; vegetable gums; pectin; proteins; collagen; egg whites; furcellaran; gelatin; ballistic gelatin; arrowroot; cornstarch; katakuri starch; potato starch; sago; tapioca; alginin; guar gum; locust bean gum; xanthan gum; sugars; agar; carrageenan; or a combination thereof.

12. The energy-absorbing device of claim 1, where the fluid comprises clays; bentonite; hectorite; smectite; attapulgite clays; colloidal metal oxides; colloidal silica; colloidal alumina; colloidal titania; colloidal zirconia; colloidal ceria; metals; colloidal gold; colloidal silver; calcium carbonate; polymers; polystyrene; polyacrylate; polymethylmethacrylate; or a combination thereof.

13. The energy-absorbing device of claim 1, where the dynamic viscosity of the fluid is about 3 to about 400 pascal-seconds when measured at a shear strain rate of about 1000 to about 12000 seconds⁻¹.

14. The energy-absorbing device of claim 4, where the magnetorheological fluid comprises iron; iron alloys; aluminum; silicon; cobalt; nickel; vanadium; molybdenum; chromium; tungsten; manganese; copper; iron oxides; iron nitride; iron carbide; carbonyl iron; nickel and alloys of nickel; cobalt and alloys of cobalt; chromium dioxide; stainless steel; silicon steel; or combinations thereof.

15. The energy-absorbing device of claim 1, where the space further comprises a foam.

16. The energy-absorbing device of claim 15, where the foam is an open cell foam.

17. The energy-absorbing device of claim 16, where a solubility parameter of the fluid differs from a solubility parameter of the foam by at least 5 MPa^{1/2}.

18. The energy-absorbing device of claim 1, where the fluid comprises ballistic gelatin.

19. The energy-absorbing device of claim 1, where the fluid comprises corn starch.

20. The energy-absorbing device of claim 1, where the fluid comprises colloidal silica.

21. The energy-absorbing device of claim 1, where the energy-absorbing device absorbs 450 joules per square meter to about 15,000 joules per square meter of energy in an impact.

22. The energy-absorbing device of claim 1, further comprising a seal that contacts the first layer and the second layer and that seals the fluid in the space between the first layer and the second layer.

23. The energy-absorbing device of claim 1, where the first layer is an outer shell and where the second layer is an inner shell that contacts a wearer.

24. The energy-absorbing device of claim 1, where the energy-absorbing device is a helmet.

25. A method of manufacturing an energy-absorbing device comprising:
disposing a fluid in a space between a first layer and a second layer; the fluid having a power law exponent n of at least about 1.3 when measured in half cell split Hopkinson bar using Equation (3) below:
$${\vert {τ}_{w} \vert}_{ma x} = {α [ \frac{U}{h} ]}^{n} = α {\dot{γ}}^{n} \qquad ( 3 )$$
where |τ_{w}|ₘₐₓ is a maximum shear stress, γ is a shear strain rate, α is a dynamic viscosity, U is a characteristic velocity of the striker wall, h is a thickness of the space, n is a power law exponent that represents an energy dissipating property of the fluid; and
sealing the space with a seal that contacts the first layer and the second layer.

26. The method of claim 25, further comprising disposing a valve on the seal.

27. The method of claim 25, further comprising disposing a foam in the space, where a solubility parameter of the fluid differs from a solubility parameter of the foam by at least 5 MPa^{1/2}.

28. A method comprising:
disposing upon an article or upon a living being an energy-absorbing device comprising:
a first layer;
a second layer; the second layer being opposedly disposed to the first layer and in slideable communication with the first layer; the first layer and the second layer enclosing a space therebetween; the space being filled with a fluid that has a power law exponent n of at least about 1.3 when measured in half cell split Hopkinson bar using Equation (3) below:
$${\vert {τ}_{w} \vert}_{ma x} = {α [ \frac{U}{h} ]}^{n} = α {\dot{γ}}^{n} \qquad ( 3 )$$
where |τ_{w}|ₘₐₓ is a maximum shear stress, γ is a shear strain rate, α is a dynamic viscosity, U is a characteristic velocity of a striking wall, h is a thickness of the space, n is a power law exponent that represents an energy dissipating property of the fluid; and
impacting the energy-absorbing device.

29. A helmet comprising:
a first layer; and
a second layer; the second layer being opposedly disposed to the first layer and in slideable communication with the first layer; the first layer and the second layer enclosing a space therebetween; the space containing one or more pouches filled with a first shear thickening fluid; and wherein spaces between the one or more pouches is filed with a second fluid; the second fluid being different from the first fluid.

30. The helmet of claim 29, where there are at least 5 pouches disposed between the first layer and the second layer.
